(19) United States
(12) Patent Application Publication
(10) Pub. No.: US 2014/0344114 A1
(43) Pub. Date: Nov. 20, 2014

(54) METHODS AND SYSTEMS FOR SEGMENTING QUERIES

(71) Applicants: Prasad Sriram, Manchester.., CT (US); Mohammad Al Hasan, Fortville, IN (US); Nishith Parikh, Fremont, CA (US)

(72) Inventors: Prasad Sriram, Manchester.., CT (US); Mohammad Al Hasan, Fortville, IN (US); Nishith Parikh, Fremont, CA (US)

(21) Appl. No.: 14/143,264

(22) Filed: Dec. 30, 2013

Related U.S. Application Data
(60) Provisional application No. 61/824,905, filed on May 17, 2013.

(51) Int. Cl. G06Q 30/06

(52) U.S. Cl. CPC G06Q 30/0625
USPC 705/26.62

(57) ABSTRACT

Apparatus and method for segmentation of text-based user input are disclosed herein. In some embodiments, a text snippet is received from a search interface. The text snippet may include a plurality of units that are each separated by a separation character. A plurality of unit groupings are then generated from the plurality of units. Each unit grouping is scored based on a frequency that the unit grouping is present in a buyer vocabulary and further on a frequency that the each unit grouping is present in a seller vocabulary. A segmented version of the text snippet is generated based on the scoring of the plurality of unit groupings.

### RELATED APPLICATIONS

This application claims the benefit of U.S. Provisional Application No. 61/824,905, filed May 17, 2013, entitled “Query Segmentation,” which is herein incorporated by reference in its entirety.

### TECHNICAL FIELD

The present invention relates generally to handling of queries, and, in some embodiments, to segmenting a query.

### BACKGROUND

Electronic marketplaces may list many items for sale (e.g., hundreds of millions, or more). To assist buyers in locating items that may be of interest, most conventional electronic marketplaces may provide a search interface to the buyer population. The buyer may then submit a text string to cause the electronic marketplace to find matching listings. In matching a text string to one or more listings, a text string treated as a bag of words using white space as delimiter, and any active item whose title or description text contains all the words of the query is considered a relevant item for that query. The relevant items are displayed as an ordered list after they are sorted using a ranking function. A user can view, click or buy items from the search result page.

Thus, the items returned by searches performed by conventional electronic marketplaces are largely dictated by the search terms submitted by the buyer initiating the search.

### BRIEF DESCRIPTION OF THE DRAWINGS

Some embodiments are illustrated by way of example and not limitations in the figures of the accompanying drawings, in which:

FIG. 1 illustrates a block diagram depicting a network architecture of a system, according to some embodiments, having a client-server architecture configured for exchanging data over a network.

FIG. 2 illustrates a block diagram showing components provided within the system of FIG. 1 according to some embodiments.

FIG. 3 is a flowchart of a method for segmenting a query based on frequency scored determined by a seller vocabulary and a buyer vocabulary, according to an example embodiment.

FIG. 4 is a diagram illustrating multiple unit groupings derived from a text snippet, according to an example embodiment.

FIG. 5 is a diagram illustrating a text index stored in the database, according to an example embodiment.

FIG. 6 is a diagram illustrating a segmented version of the text snippet generated based on the unit groupings, according to an example embodiment.

FIG. 7 is a flow chart of a method for building a text index, according to an example embodiment.

FIG. 8 is a flowchart illustrating a method for measuring the efficacy of a segmentation function, according to an example embodiment.

FIG. 9 illustrates a diagrammatic representation of a machine in the example form of a computer system within which a set of instructions may be executed to cause the machine to perform any one or more of the methodologies discussed herein.

The headings provided herein are for convenience only and do not necessarily affect the scope or meaning of the terms used.

### DETAILED DESCRIPTION

Described in detail herein is an apparatus and method for segmentation of text-based queries to improve query disambiguation, query reformulation, product/service results corresponding to the query, query suggestion, product/service recommendations that complement the product/service results corresponding to the query, and/or query ranking.

Various modifications to the example embodiments will be readily apparent to those skilled in the art, and the generic principles defined herein may be applied to other embodiments and applications without departing from the scope of the invention. Moreover, in the following description, numerous details are set forth for the purpose of explanation. However, one of ordinary skill in the art will realize that the invention may be practiced without the use of these specific details. In other instances, well-known structures and processes are not shown in block diagram form in order not to obscure the description of the invention with unnecessary detail. Thus, the present disclosure is not intended to be limited to the embodiments shown, but is to be accorded the widest scope consistent with the principles and features disclosed herein.

According to some example embodiments, a text snippet is received from a user interface, such as a search interface or a user interface to list an item for sale through an electronic commerce site. The text snippet may include a plurality of units (e.g., words) separated by a separation character (e.g., white space). The units of the text snippet are then grouped to generate unit groupings. Each unit grouping is then scored based on a frequency that that unit grouping is present in a buyer vocabulary and further on a frequency that that unit grouping is present in a seller vocabulary. A segmented version of the text snippet is generated based on the scoring of the plurality of unit groupings. For example, multiple individual units may be replaced by a unit grouping, such that the unit grouping is treated as a single unit.

As is described below in greater detail, query segmentation may find many practical applications, such as improving the precision of search queries, search result rankings, and query modifications or rewrites. Such may be the case because the segmented version of the text snippet may more closely represent the intent of the user by treated a unit grouping as a syntactical unit, rather than individual syntactic units.

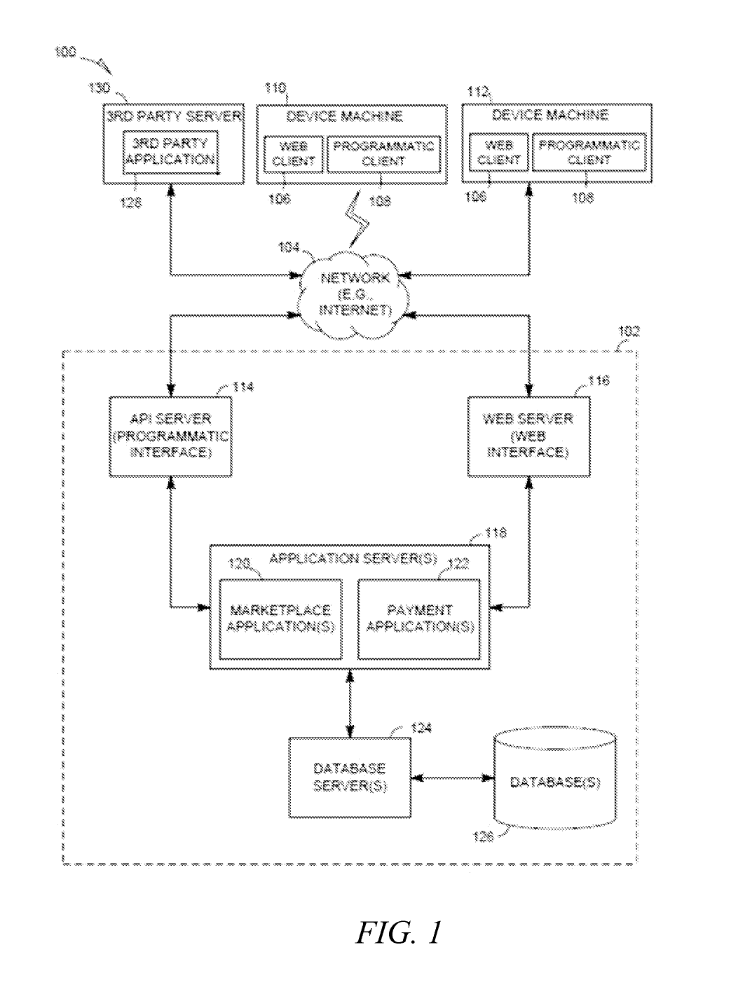

FIG. 1 illustrates a network diagram depicting a network system 100, according to one embodiment, having a client-server architecture configured for exchanging data over a network. A networked system 102 forms a network-based publication system that provides server-side functionality, via a network 104 (e.g., the Internet or Wide Area Network (WAN)), to one or more clients and devices. FIG. 1 further illustrates, for example, one or both of a web client 106 (e.g., a web browser) and a programmatic client 108 executing on device machines 110 and 112. In one embodiment, the publication system 100 comprises a marketplace system. In another embodiment, the publication system 100 comprises other types of systems such as, but not limited to, a social networking system, a matching system, a recommendation system, an electronic commerce (e-commerce) system, a search system, and the like.

Each of the device machines 110, 112 comprises a computing device that includes at least a display and communication capabilities with the network 104 to access the networked system 102. The device machines 110, 112 comprise, but are not limited to, remote devices, work stations, computers, general purpose computers, Internet appliances, hand-held devices, wireless devices, portable devices, wearable computers, cellular or mobile phones, portable digital assistants (PDAs), smart phones, tablets, ultrabooks, netbooks, laptops, desktops, multi-processor systems, microprocessor-based or programmable consumer electronics, game consoles, set-top boxes, network PCs, mini-computers, and the like. Each of the device machines 110, 112 may connect with the network 104 via a wired or wireless connection. For example, one or more portions of network 104 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, a wireless network, a WiFi network, a WiMax network, another type of network, or a combination of two or more such networks.

Each of the device machines 110, 112 includes one or more applications (also referred to as “apps”) such as, but not limited to, a web browser, messaging application, electronic mail (email) application, an e-commerce site application (also referred to as a marketplace application), and the like. In some embodiments, if the e-commerce site application is included in a given one of the device machines 110, 112, then this application is configured to locally provide the user interface and at least some of the functionalities with the application configured to communicate with the networked system 102, on an as needed basis, for data and/or processing capabilities not locally available (such as access to a database of items available for sale, to authenticate a user, to verify a method of payment, etc.). Conversely if the e-commerce site application is not included in a given one of the device machines 110, 112, the given one of the device machines 110, 112 may use its web browser to access the e-commerce site (or a variant thereof) hosted on the networked system 102. Although two device machines 110, 112 are shown in FIG. 1, more or less than two device machines can be included in the system 100.

An Application Program Interface (API) server 114 and a web server 116 are coupled to, and provide programmatic and web interfaces respectively to, one or more application servers 118. The application servers 118 host one or more marketplace applications 120 and payment applications 122. The application servers 118 are, in turn, shown to be coupled to one or more databases servers 124 that facilitate access to one or more databases 126.

The marketplace applications 120 may provide a number of e-commerce functions and services to users that access networked system 102. E-commerce functions/services may include a number of publisher functions and services (e.g., search, listing, content viewing, payment, etc.). For example, the marketplace applications 120 may provide a number of services and functions to users for listing goods and/or services or offers for goods and/or services for sale, searching for goods and services, facilitating transactions, and reviewing and providing feedback about transactions and associated users. Additionally, the marketplace applications 120 may track and store data and metadata relating to listings, transactions, and user interactions. In some embodiments, the marketplace applications 120 may publish or otherwise provide access to content items stored in application servers 118 or databases 126 accessible to the application servers 118 and/or the database servers 124. The payment applications 122 may likewise provide a number of payment services and functions to users. The payment applications 122 may allow users to accumulate value (e.g., in a commercial currency, such as the U.S. dollar, or a proprietary currency, such as “points”) in accounts, and then later to redeem the accumulated value for products or items (e.g., goods or services) that are made available via the marketplace applications 120. While the marketplace and payment applications 120 and 122 are shown in FIG. 1 to both form part of the networked system 102, it will be appreciated that, in alternative embodiments, the payment applications 122 may form part of a payment service that is separate and distinct from the networked system 102. In other embodiments, the payment applications 122 may be omitted from the system 100. In some embodiments, at least a portion of the marketplace applications 120 may be provided on the device machines 110 and/or 112.

Further, while the system 100 shown in FIG. 1 employs a client-server architecture, embodiments of the present disclosure is not limited to such an architecture, and may equally well find application in, for example, a distributed or peer-to-peer architecture system. The various marketplace and payment applications 120 and 122 may also be implemented as standalone software programs, which do not necessarily have networking capabilities.

The web client 106 accesses the various marketplace and payment applications 120 and 122 via the web interface supported by the web server 116. Similarly, the programmatic client 108 accesses the various services and functions provided by the marketplace and payment applications 120 and 122 via the programmatic interface provided by the API server 114. The programmatic client 108 may, for example, be a seller application (e.g., the TurboLister application developed by eBay Inc., of San Jose, Calif.) to enable sellers to author and manage listings on the networked system 102 in an off-line manner, and to perform batch-mode communications between the programmatic client 108 and the networked system 102.

FIG. 1 also illustrates a third party application 128, executing on a third party server machine 130, as having programmatic access to the networked system 102 via the programmatic interface provided by the API server 114. For example, the third party application 128 may, utilizing information retrieved from the networked system 102, support one or more features or functions on a website hosted by the third party. The third party website may, for example, provide one or more promotional, marketplace, or payment functions that are supported by the relevant applications of the networked system 102.

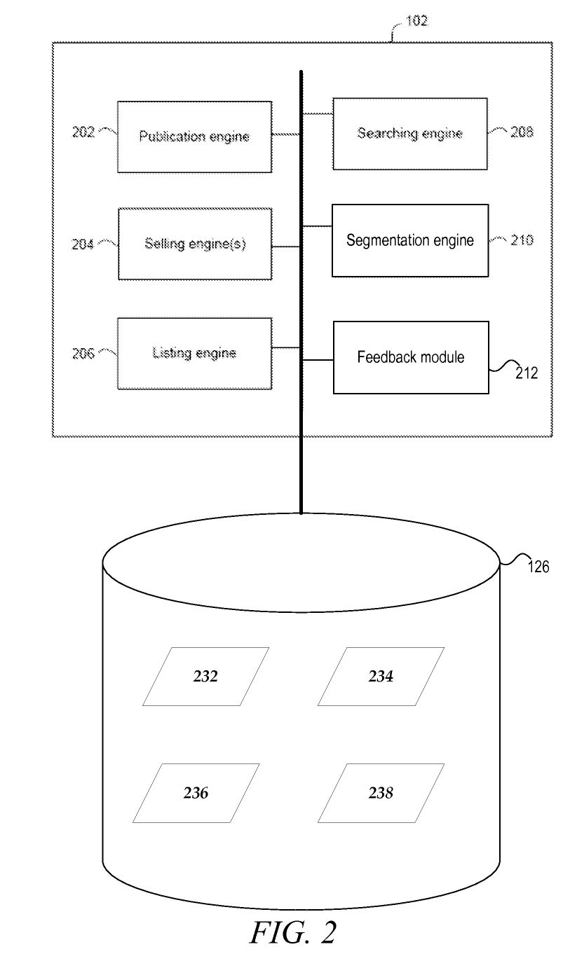

FIG. 2 illustrates a block diagram showing components provided within the networked system 102 according to some embodiments. The networked system 102 may be hosted on dedicated or shared server machines (not shown) that are communicatively coupled to enable communications between server machines. The components themselves are communicatively coupled (e.g., via appropriate interfaces) to each other and to various data sources, so as to allow information to be passed between the applications or so as to allow the applications to share and access common data. Furthermore, the components may access one or more databases 126 via the database servers 124.

The networked system 102 may provide a number of publishing, listing, and/or price-setting mechanisms whereby a seller (also referred to as a first user) may list (or publish information concerning) goods or services for sale or barter, a buyer (also referred to as a second user) can express interest in or indicate a desire to purchase or barter such goods or services, and a transaction (such as a trade) may be completed pertaining to the goods or services. To this end, the networked system 102 may comprise at least one publication engine 202 and one or more selling engines 204. The publication engine 202 may publish information, such as item listings or product description pages, on the networked system 102. In some embodiments, the selling engines 204 may comprise one or more fixed-price engines that support fixed-price listing and price setting mechanisms and one or more auction engines that support auction-format listing and price setting mechanisms (e.g., English, Dutch, Chinese, Double, Reverse auctions, etc.). The various auction engines may also provide a number of features in support of these auction-format listings, such as a reserve price feature whereby a seller may specify a reserve price in connection with a listing and a proxy-bidding feature whereby a bidder may invoke automated proxy bidding. The selling engines 204 may further comprise one or more deal engines that support merchant-generated offers for products and services.

A listing engine 206 allows sellers to conveniently author listings of items or authors to author publications. In one embodiment, the listings pertain to goods or services that a user (e.g., a seller) wishes to transact via the networked system 102. In some embodiments, the listings may be an offer, deal, coupon, or discount for the good or service. Each good or service is associated with a particular category. The listing engine 206 may receive listing data such as title, description, and aspect name/value pairs. Furthermore, each listing for a good or service may be assigned an item identifier. In other embodiments, a user may create a listing that is an advertisement or other form of information publication. The listing information may then be stored to one or more storage devices coupled to the networked system 102 (e.g., databases 126). Listings also may comprise product description pages that display a product and information (e.g., product title, specifications, and reviews) associated with the product. In some embodiments, the product description page may include an aggregation of item listings that correspond to the product described on the product description page.

The listing engine 206 also may allow buyers to conveniently author listings or requests for items desired to be purchased. In some embodiments, the listings may pertain to goods or services that a user (e.g., a buyer) wishes to transact via the networked system 102. Each good or service is associated with a particular category. The listing engine 206 may receive as much or as little listing data, such as title, description, and aspect name/value pairs, that the buyer is aware of about the requested item. In some embodiments, the listing engine 206 may parse the buyer's submitted item information and may complete incomplete portions of the listing. For example, if the buyer provides a brief description of a requested item, the listing engine 206 may parse the description, extract key terms and use those terms to make a determination of the identity of the item. Using the determined item identity, the listing engine 206 may retrieve additional item details for inclusion in the buyer item request. In some embodiments, the listing engine 206 may assign an item identifier to each listing for a good or service.

In some embodiments, the listing engine 206 allows sellers to generate offers for discounts on products or services. The listing engine 206 may receive listing data, such as the product or service being offered, a price and/or discount for the product or service, a time period for which the offer is valid, and so forth. In some embodiments, the listing engine 206 permits sellers to generate offers from the sellers' mobile devices. The generated offers may be uploaded to the networked system 102 for storage and tracking.

Searching the networked system 102 is facilitated by a searching engine 208. For example, the searching engine 208 enables keyword queries of listings published via the networked system 102. In example embodiments, the searching engine 208 receives the keyword queries from a device of a user and conducts a review of the storage device storing the listing information. The review will enable compilation of a result set of listings that may be sorted and returned to the client device (e.g., device machine 110, 112) of the user. The searching engine 208 may record the query (e.g., keywords) and any subsequent user actions and behaviors (e.g., navigations, selections, purchases, or click-throughs).

The searching engine 208 also may perform a search based on a location of the user. A user may access the searching engine 208 via a mobile device and generate a search query. Using the search query and the user's location, the searching engine 208 may return relevant search results for products, services, offers, auctions, and so forth to the user. The searching engine 208 may identify relevant search results both in a list form and graphically on a map. Selection of a graphical indicator on the map may provide additional details regarding the selected search result. In some embodiments, the user may specify, as part of the search query, a radius or distance from the user's current location to limit search results.

The segmentation engine 210 may be a computer-implemented module configured to generate a text index 238 based on one or more vocabularies derived from data processed in the networked system 102. As is explained in greater detail below, the text index 238 may be data or logic generated and used by the segmentation engine 210 to generate a segmentation score for unit groupings for a text snippet submitted by a user searching for items in the networked system 102. The segmentation engine 210 may also be configured to generate a segmented version of a text snippet based on segmentation function that uses data from the text index 238.

The feedback module 212 may be a computer-implemented module configured to evaluate the efficacy of a segmentation function used to segment a query. In some embodiments, the feedback module 212 may use historical queries and user activities (e.g., click-throughs and purchases) on the results of those historical queries to identify the intent of the user. The feedback module 212, according to some embodiments, may then quantify whether a segmentation function moves the search results closer to the intent of the user.

As FIG. 2 illustrates, the modules, engines, and components of the networked system 102 may access data stored by the database 126. For example, in some cases, the modules, engines, and components of the networked system 102 may access buyer vocabulary 232, seller vocabulary 234, historical user activity data 236, and the text index 238.

The buyer vocabulary 232 may be data or logic representing a query log of historical queries submitted by user of the networked system 102. In some cases, the buyer vocabulary 232 may be the queries submitted by users to the searching engine 208 over a given time period (e.g., two years, or any other suitable time frame).

The seller vocabulary 234 may be data or logic representing data derived from listings submitted to the networked system 102. Examples of seller vocabulary 234 may include titles, descriptions, catalog information, categories, keywords, and the like. Similar to the buyer vocabulary 232, the seller vocabulary 234 may be product information submitted by users to the listing engine 206 over a given time period (e.g., two years, or any other suitable time frame).

In some embodiments, the segmentation module may pre-process the data stored in the buyer vocabulary 232 and the seller vocabulary 234. For example, the segmentation module may perform term normalization (e.g., changing terms to the singular form, or to a common tense, etc.), stemming, blacklists, or any other function that maps related terms to the same concept.

The historical user activity data 236 may be data or logic that maps user activity with data in the buyer vocabulary 232 and the seller vocabulary 234. For example, the historical user activity data 236 may indicate what listing a buyer selects when presented results from a given search query. For example, the historical user activity data 236 may include data that specifies that a user has clicked on a listing for an IPHONE®, or a clicked on a category associated with smart phones, when the buyer uses a search query of “APPLE.” Other user activity may include purchases, other search terms, and the like that are performed respective to a given listing-search query pair.

The text index 238 may be data or logic that maps unit groupings to one or more grouping scores. One type of grouping score for the text index 238 may be derived based on the frequency that the unit grouping occurs in the buyer vocabulary 232. Another type of grouping score for the text index 238 may be derived based on the frequency that the unit grouping occurs in the buyer vocabulary 234. Yet another type of grouping score for the text index 238 may be derived based on the size of the unit grouping, as may be measured by the number of characters in the unit grouping or the number of words. It is to be appreciated that the above types of grouping scores are provided for the purpose of illustration and should not limit embodiments contemplated by this disclosure. For example, other example embodiments may include a grouping score for the text index 238 that is derived from community data, such as titles in WIKIPEDIA®.

Additional modules, components, and engines associated with the networked system 102 may be included to perform embodiments described herein. It should be appreciated that these and other modules, components, or engines may embody various aspects of the details described below.

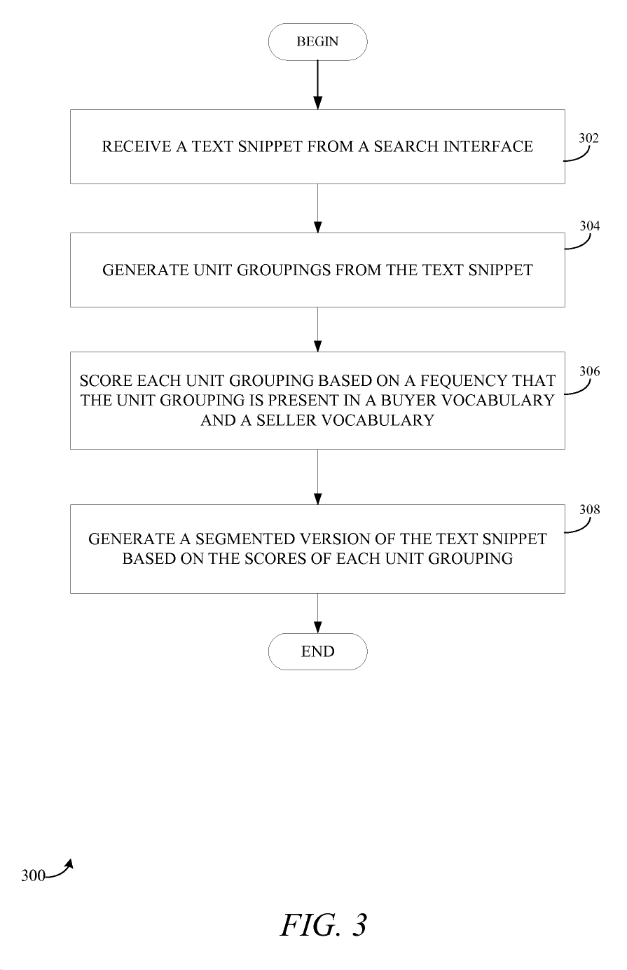

FIG. 3 is a flowchart of a method 300 for segmenting a query based on frequency scored determined by a seller vocabulary and a buyer vocabulary, according to an example embodiment. The method 300 may be performed by the segmentation engine 210 of FIG. 2 and, accordingly, is described herein merely by way of reference thereto. However, it will be appreciated that the method 300 may be performed on any suitable hardware.

FIG. 3 shows that the method 300 may begin at operation 302 when the segmentation engine 210 receives a text snippet through a search interface. A text snippet may be a sequence of characters, numbers, symbols, or the like submitted by a user of the networked system 102 which may be part of a search request. The text snippet may include a plurality of units that represent phonemes, syllables, letters, words or base pairs according to the embodiment. The units of the text snippet may be separated from each other by separation characters, such as white space, quotes, brackets, comas, semi-colon, end-of-line characters, or any other character or symbol represented by a computer. It is to be appreciated that the text snippet, as a whole, may follow a particular syntax and/or grammar, which may include logical operators, grouping operators, regular expressions and wildcards, and the so forth.

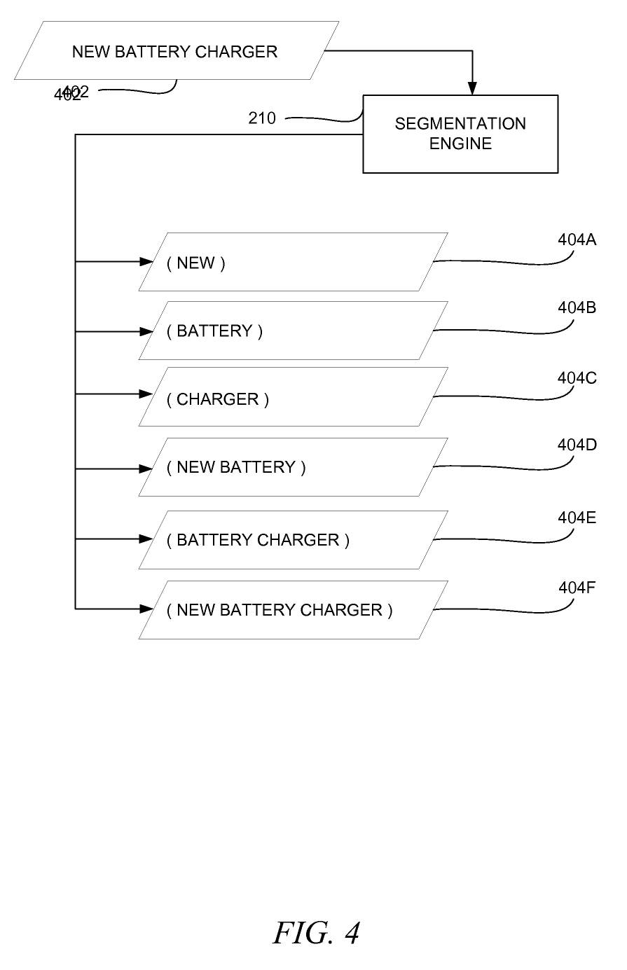

At operation 304, the segmentation engine 210 may generate unit groupings from the plurality of units. A unit grouping may include an n-gram that groups two or more units from the text snippet as a single unit. To illustrate the operations 302, 304, FIG. 4 is a diagram illustrating multiple unit groupings 404A-F derived from a text snippet 402, according to an example embodiment. As shown in FIG. 4, the text snippet 402 may be a text string with the individual units (e.g., words): NEW, BATTERY, and CHARGER. It is to be appreciated that performing a search using the text snippet 402 may cause the searching engine 208 to identify listings that have titles with each of these words. In some cases, this search may be over-inclusive, as the searching engine 208 does not apply a strict ordering or sequence of the units of the text snippet. In other cases, this search may be under-inclusive, as, perhaps, many listing that would be considered relevant lack the term “NEW” in their title and, as a result, would not be a match for the text snippet 402.

As shown in FIG. 4, the segmentation engine 210 uses the text snippet 402 to generate the unit groupings 404A-F. Each of the unit groupings may be an n-gram (a unigram, bigram, trigram, and so forth) from the units found in the text snippet 402. An n-gram may be a contiguous sequence of n units found in the text snippet. For example, the unit grouping 404D, “NEW BATTERY,” may be a bigram because “NEW” and “BATTERY” are found together, in that order, in the text snippet. The other unit groupings 404A-C and 404E-F also include groupings of units found contiguously in the text snippet.

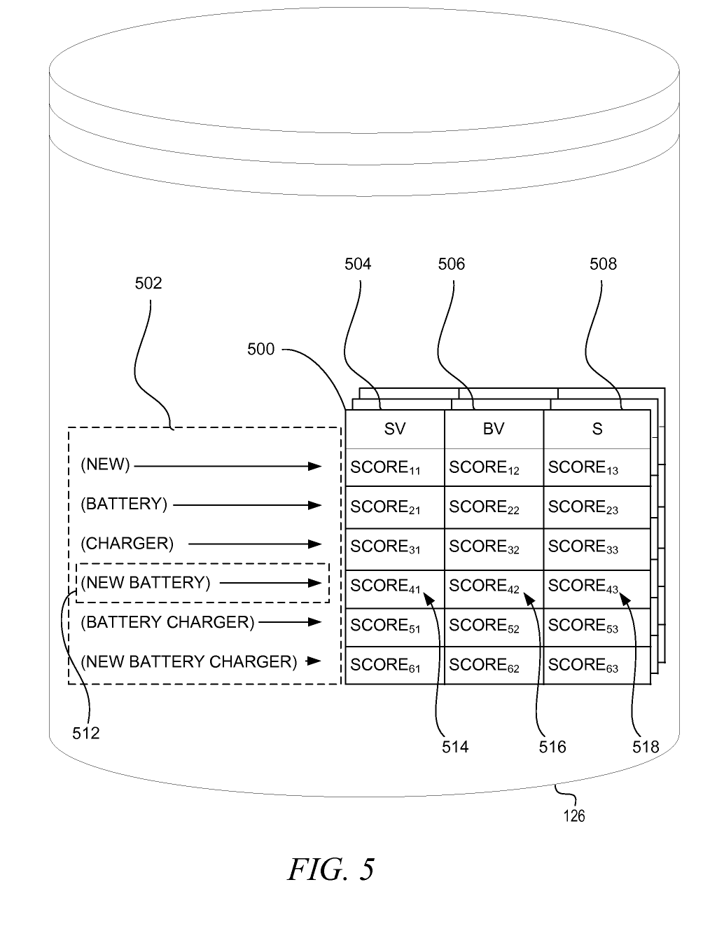

With reference back to FIG. 3, at operation 306, the segmentation engine 210 may then score each unit grouping based on a frequency that that unit grouping is present in a buyer vocabulary and, further, on a frequency that that that unit grouping is present in a seller vocabulary. Operation 406 is explained in further detail with respect to FIG. 5. FIG. 5 is a diagram illustrating a text index 500 stored in the database 126, according to an example embodiment. The text index 500 may be a data structure that includes data for generating scores for unit groupings. For example, the text index 500 may be indexed according to a unit grouping key 502. Further, the text index 500 may include, for each unit grouping key, values to one or more scoring factors, 504, 506, 508. In an example embodiment, the scoring factor 504 may be a value derived from a frequency that a unit grouping is found in a buyer vocabulary, the scoring factor 506 may be a value derived from a frequency that a unit grouping is found in a seller vocabulary, the scoring factor 508 may be a value derived from a size (e.g., number of characters, number, symbols, words, etc.) of a unit grouping. Thus, each unit grouping may have corresponding values to one or more of scoring factors 504, 506, and 508. For example, the “NEW BATTERY” unit grouping key 512 may have scores corresponding to scoring factor 514 (e.g., the frequency in which “NEW BATTERY” appears in the buyer vocabulary), scoring factor 516 (e.g., the frequency in which “NEW BATTERY” appears in the seller vocabulary), and scoring factor 518 (e.g., the size of the unit grouping “NEW BATTERY”).

As FIG. 5 shows, there may be additional text indexes aside from text index 500. For example, the segmentation engine 210 may build and select from multiple text indexes according to a category of listing item. For example, the text index 500 may be built based on frequency of unit groupings being found in vocabularies specific to an “ELECTRONICS” category.

It is to be appreciated that the text index 500 is provided by way of example and not limitation, and other embodiments may differ in the data stored therein. For example, in some cases, the text index 500 may include more or less scoring factors. An example of another scoring factor that may be stored by the text index 500 is a community score, which is a value derived from the presence of a unit grouping being found in community data (e.g., a title of a community data source (e.g., WIKIPEDIA.COM®, for example).

Returning back to FIG. 3, the method 300 continues at operation 308 when the segmentation engine 210 generates a segmented version of the text snippet based on the scoring of the unit groupings. In some cases, the segmentation engine 210 may perform operation 308 by replacing one or more units of the text snippet with a corresponding unit grouping. A unit grouping may correspond to a unit (or units) of the text snippet when the unit (or units) form part of the unit grouping.

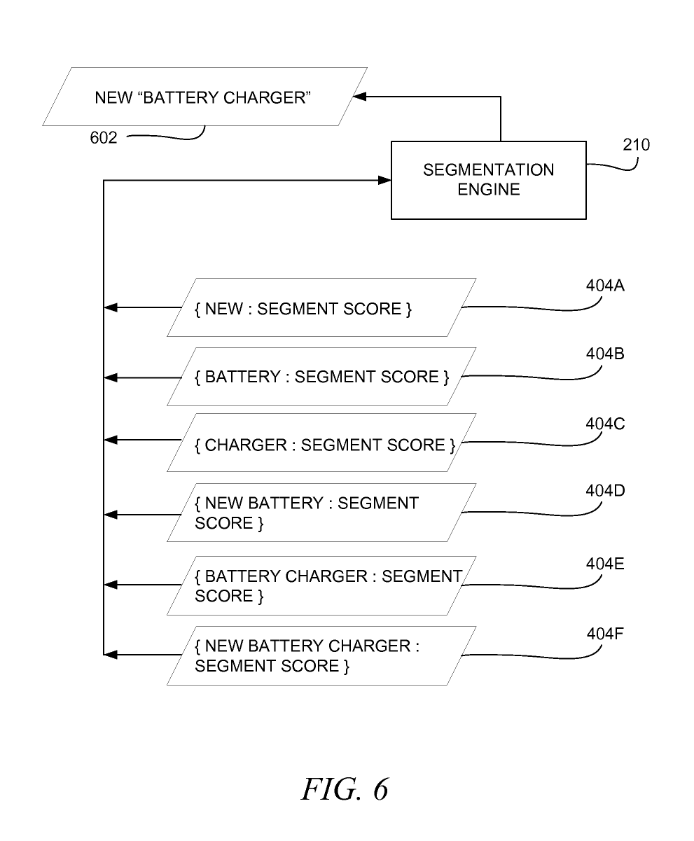

To illustrate the operations 308, FIG. 6 is a diagram illustrating a segmented version of the text snippet generated based on the unit groupings 404A-F, according to an example embodiment. As shown in FIG. 6, each of the unit groupings 404A-F may include respective segment scores. A segmentation function may calculate a segment score for a given unit grouping based on the scoring factors specified by the index table for the given unit grouping. For example, with momentary reference back to FIG. 5, a segmentation function may calculate the segment score for the unit grouping 404D based on the scoring factors 514, 516, 518 indexed by the unit grouping key 512.

Compared to the text snippet 402 shown in FIG. 4, the segmented version 602 shown in FIG. 6 may include search terms that groups together “BATTERY CHARGER,” rather than listing “BATTERY” and “CHARGER” as separate units. In some cases, the segmentation engine 210 may replace individual units in the text snippet with a unit grouping based on a comparison of the segment score of the unit grouping and the combined segment scores of the constituent units of the unit grouping. For example, if a unit grouping “BATTERY CHARGER” has a greater segmentation score that the aggregate segmentation score for “BATTERY” and “CHARGER,” the segmentation engine 210 may generate a segmented version of the text snippet by replacing the occurrences of “BATTERY” and “CHARGER” with “BATTERY CHARGER.”

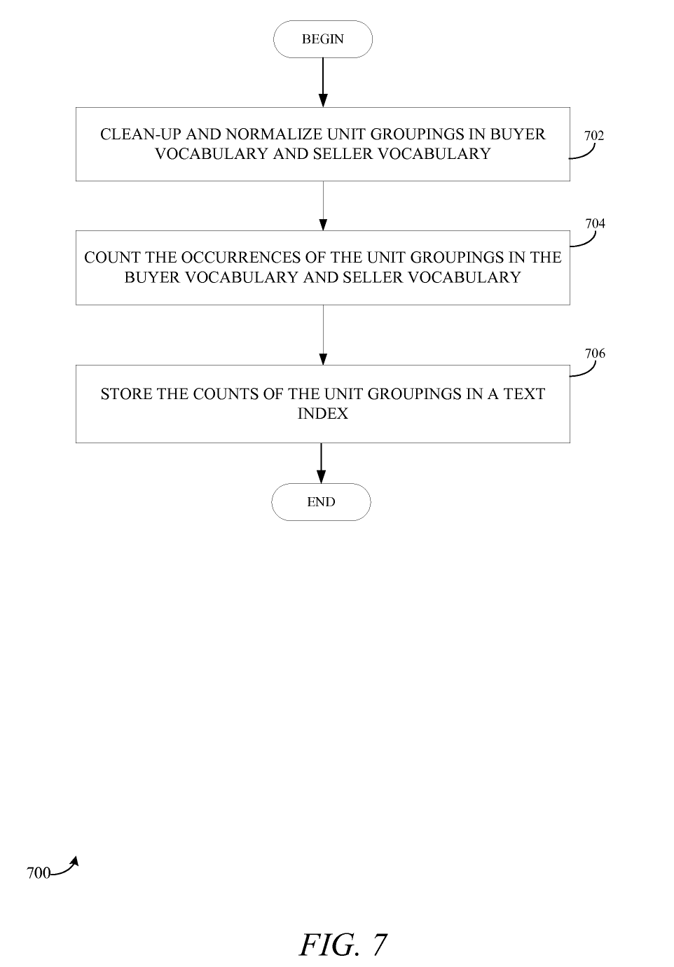

Thus, according to the above description, some embodiments may provide a mechanism to segment a text snippet in which a text index is used. FIG. 7 is a flow chart of a method 700 for building a text index, according to an example embodiment. The method 700 may be performed by the segmentation engine 210 of FIG. 2 and, accordingly, is described herein merely by way of reference thereto. However, it will be appreciated that the method 700 may be performed on any suitable hardware.

The method 700 may begin at operation 702 when the segmentation engine 210 cleans-up and normalizes unit groupings (e.g., n-grams) found in the buyer vocabulary 232 and seller vocabulary 234. In some cases, the segmentation engine 210 may process unit groupings up to a specified cardinality (e.g., the number of unit comprised within the unit grouping). By way of example and not limitation, the segmentation engine 210 may consider up to 9-grams (or more), which, depending on the vocabulary, may cover a significant portion of the queries in the buyer vocabulary and the product data in the seller vocabulary.

At operation 704, the segmentation engine 210 may count the frequency of the unit groupings within the buyer vocabulary and seller vocabulary for the given period of time. Operation 704 may, in some embodiments, also devises a composite score for a unit grouping that uses the frequency values from the buyer and seller vocabularies. Then using a heuristically determined threshold for this composite score, it discards unit groupings whose scores fall short of this threshold. The remaining unit groupings may then be processed by the segmentation engine 210.

In some embodiments, the segmentation engine 210 may execute operation 704 such that the count of frequencies is organized according to a category. For example, the segmentation engine 210 may generate separate unit grouping scores for each category. In other example embodiments, multiple text indexes may be created, one for each category. Organizing the seller vocabulary 234 based on category may be based on the category information provided by the seller when they list the product for sale in the networked system 102. For the buyer vocabulary 232, the segmentation engine 210 may use a classifier to classify a query as being directed to a category. If the query is available in the seller vocabulary 234 with a minimum frequency, the segmentation engine 210 may use the most frequent categories used by different sellers, when they list the item on the site. If the query string does not have sufficient frequency in the seller vocabulary, then its category is obtained by creating a list of items that the shoppers click after they have issued the query. Thus, the query is mapped to a set of products that are relevant to that query. Then, using the categories of these products, the segmentation engine 210 determines the category of that query.

After classification of vocabularies, the segmentation engine 210 may build a set of vocabularies (e.g., sets of buyer vocabularies and sets of seller vocabularies) for each of the categories. For example, the segmentation engine 210 may compute the frequencies of all possible unit groupings in each of these vocabularies independently. Thus, for a unit grouping (e.g., an n-gram), different frequency values can be stored that represent the frequencies in the vocabularies belonging to different categories. As an example, consider the bigram, “NEW YORKER.” This bigram can appear in many queries that belong to different categories. For instance, “NEW YORKER” may appear in the query “THE NEW YORKER MAGAZINE,” which belongs to the “BOOKS” category; in the query “CHRYSLER NEW YORKER,” which belongs to the “MOTORS” category; in the query “MICHAEL KORS NEW YORKER BAG,” which belongs to the “CLOTHING, SHOES & ACCESSORIES” category; in the query “NEW YORKER RESTORATION,” which belongs to the “POTTERY & GLASS” category; and so on. Thus, the bigram “NEW YORKER” will have different frequency values corresponding to different categories.

At operation 706, the counts of the unit groupings are stored in one or more text indexes. Where the segmentation engine 210 maintains counts on a category bases, the counts may be stored in text indexes for one or more categories to which the count refers.

Some embodiments may provide a mechanism to evaluate the efficacy of a segmentation function used to generate segmented versions of a text snippet. For example, the feedback module 212 of FIG. 2 may use an evaluation metric referred to as a user-intent-score that measures or characterizes an extent by which a segmented version of a text snippet improves the search results when compared to the search results generated from the unmodified text snippet. To generate a user-intent-score, the feedback module 212 may use click-through data collected from prior search queries executed on the networked system 102. For example, when a user clicks or buys a product, the feedback module 212 may consider that product, and in turn, the category associated with the product, to be relevant for the given query.

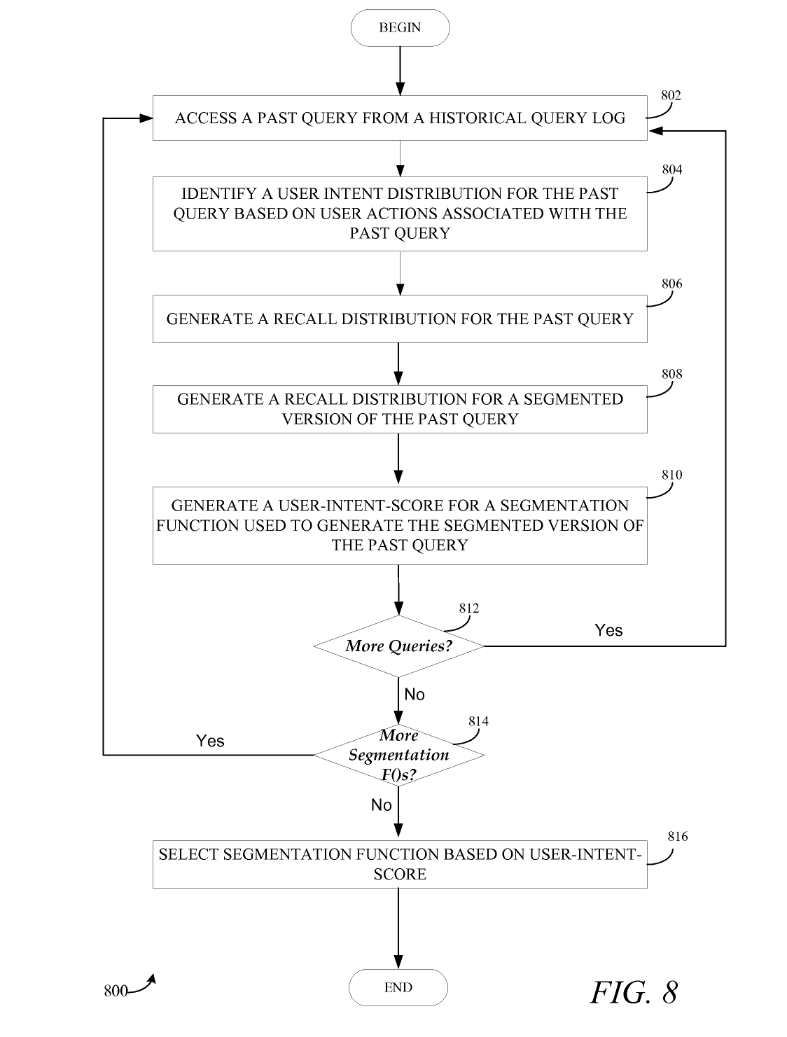

FIG. 8 is a flowchart illustrating a method 800 for measuring the efficacy of a segmentation function, according to an example embodiment. The method 800 may be performed by the feedback module 212 of FIG. 2 and, accordingly, is described herein merely by way of reference thereto. However, it will be appreciated that the method 800 may be performed on any suitable hardware.

The method 800 may begin at operation 802 when the feedback module 212 accesses a past query from a historical query log. As described above, the historical query log may be a data store that tracks the queries that were previously executed by the networked system 102, along with the user actions on the search result generated from the query. In some cases the user actions may specify a product or category of product the user selected or purchased.

At operation 804, the feedback module 212 may identify a user intent distribution from the products associated with the user actions stored relative to the past query. The user intent distribution may be a distribution of products or categories associated with the listing that the users clicked on or purchased based on executing the past query. The user intent distribution may then identify that when a given query is executed by the networked system 102, 70% of the time users will click on a first type of product or product category, 15% will click on a second type of product or category, 10% will click on a third type of product or category, and 5% will click on a fourth type of product or category. Thus, the user intent distribution may be used to represent the intent of a user when the user initiates a search using a given search query.

At operation 806, the feedback module 212 may then generate a recall distribution for the past query based on causing the searching module to rerun a search on the listing database using the past query. The recall distribution may identify a distribution of products or categories that are found in the results generated by executing the past search query. That is, the recall distribution may be data or logic that represents the categories or products that the networked system 102 returns to the user based on the given search query.

At operation 808, the feedback module 212 may then generate a recall distribution for a segmented version of the past query by causing the searching module to perform a search on the listing database using the segmented version past query. The segmented version of the past query may be generated using a selected segmentation function, which may be based on a function of the frequency of occurrences of the unit groupings in a buyer vocabulary, a seller vocabulary, a grouping length, or any other suitable scoring factor. Similar to the recall distribution for the past query, the recall distribution generated for the segmented version of the past query may identify a distribution of categories or products that are found in the results generated by executing the segmented version of the past search query. That is, the recall distribution for the segmented version of the past query may be data or logic that represents the categories or products that the networked system 102 returns to the user based on executing the segmented version of the given search query.

At operation 810, the feedback module 212 may generate a user-intent-score for the segmentation function used to generate the segmented version of the past query based on a comparison of a divergence between the user intent distribution and the recall distribution for the segmented version and a divergence between the user intent distribution and the recall distribution for the past query. That is, operation 810 may be used to measure an improvement to the search result obtained by using the segmented version of the past query over using the original unsegmented version. Such a measurement may be used to quantify the efficacy of the segmentation function. It is to be appreciated, as shown in FIG. 8, that the operations 802-810 may be repeated, based on decision 812, for other past queries to calculate an aggregated user-intent-score for the segmentation function over multiple past queries.

It is to be appreciated, as shown in FIG. 8, that the operations 802-810 may be repeated, based on decision 814, for other segmentation functions to quantify the improvement of other segmentation functions. The user-intent-score may be surfaced to an administrator of the networked system 102. The administrator may then use the user-intent-score to evaluate the efficacy of a particular segmentation function.

An example embodiment may use Kullback-Leibler (“KL”)-divergence to generate the user-intent-score for the segmentation function. KL-divergence is a non-symmetric measure of the difference between two probability distributions, such as the user intent distribution and the recall distribution for the segmented version, or, as another example, the user intent distribution and the recall distribution for the past query. It is to be appreciated that other divergence functions may be used, such as histogram intersection, Chi-squared statistic, quadratic form distance, match distance, Kolmogorov-Smirnov distance, and earth mover's distance.

At operation 816, the feedback module 212 may select the segmentation function based on the user-intent-score. Operation 812 may involve the feedback module 212 selecting the segmentation function based on a user-intent-score that is, for example, positive, or that is relatively higher than other user-intent-scores generated for other segmentation functions. Operation 812 may be used to automate the selection the segmentation function over other segmentation functions, if any are to be used at all.

Query segmentation may have many practical uses within the networked system 102. For example, query segmentation can be used, in some cases, to improving the precision of product search in the networked system 102. For example, consider that some search engines may treat each term in a query independent from each other and, as a result, produce results that include products with titles or descriptions that contain all the words in the query but not necessarily in the order presented in the search query. So, for a query like “MICHAEL JACKSON”, the recall set might have products that possess the terms MICHAEL and JACKSON in their product description, but not necessarily in that order or together as a phrase. Thus, the query will inaccurately match products (false positives) whose descriptions contain both the following phrases: “MICHAEL JORDAN” and “JANET JACKSON.” These false positives negatively affect the precision metric. But, by considering the query “MICHAEL JACKSON” as a syntactic unit, the false positive products can be excluded from the result-set. In summary, the intent of the user is more closely captured by looking at intent units (query segments) in the queries, rather than tokenizing on white space for individual term-based retrieval.

As another example, query segmentation can be used, in some cases, to improving the search results generated by the networked system 102. In a web-search scenario, a predominant factor for ranking web documents is the PageRank® value of a web page, which is a score obtained from the underlying topology of a Web graph. Unfortunately, for items listed in an electronic commerce sites, graph-based rankings may not be available, which makes product ranking a more challenging task. For product ranking, a product's relevance to a given query can be used to generate a relative ranking of the search results. One of the ways example embodiments may measure a product's relevance to a given query is to find whether the product information (e.g., title or description) of the product matches with some of the syntactical units of a query. For that, the segmentation engine 210 may segmentation the query before performing the rankings of the search results.

Some embodiment may use query segmentation to improve query suggestion. Query suggestion generally provides users with an option to narrow down a search result to the product of interest or explore related products. Various approaches are used in the design of query suggestion systems but at the heart of all such systems are ways to find queries that are semantically related to a given query. However, using an approach that considers each unit of a text query as separate units may result in improper suggestions. For example, query suggestion, using white space tokenization, may determine that the search query “CHRISTINA AGUILERA POSTER” is as close to “BRITNEY SPEARS POSTER” as it is to “007 POSTER” and “TERMINATOR POSTER.” However, for a term based similarity function the first pair of queries are 2 terms away whereas the second pair of queries are one term away, making the second pair of queries more similar than the first pair of queries. If instead of tokenizing on space, the segmentation engine 210 tokenizes on appropriate unit groupings and then measures distance as a function based on differences in unit groupings instead of terms, then this notion of closeness can be captured.

Another application for query segmentation is query substitution, which is also known as query rewrite. An objective of query substitution is to replace an overly specific query with a more general one that yields higher recall. This may be used to guard against zero-recall (e.g., a result set that includes zero matching listing). Zero-recall usually results in user frustration and poor user experience. However, query substitution that produces irrelevant results caused by a wrong substitution may annoy the user more than receiving a smaller or null result-set. Segmenting a query prior to running query substation application can, in some cases, help with generating better results for the suggested queries produced by query rewrite engines.

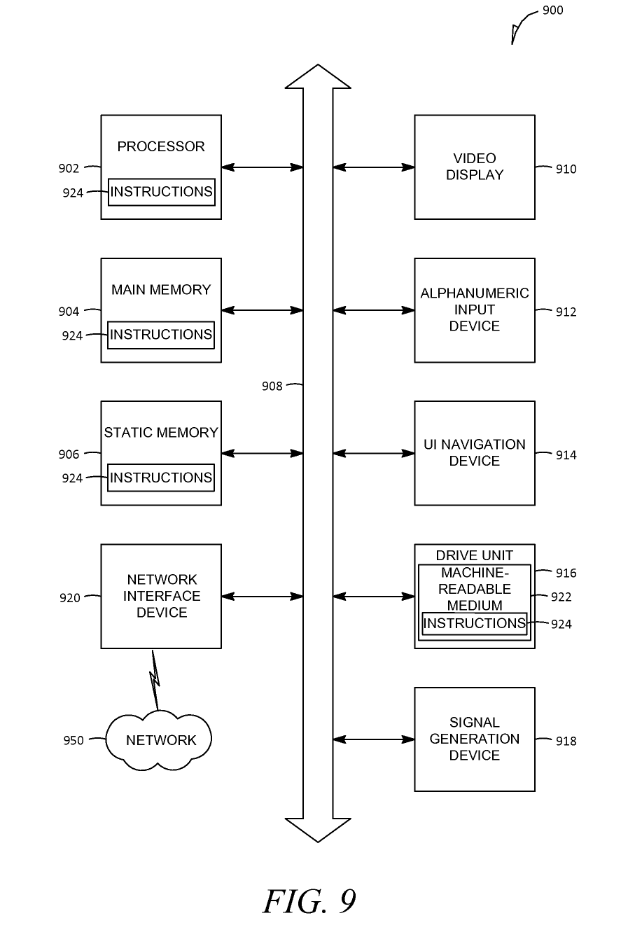

FIG. 9 shows a diagrammatic representation of a machine in the example form of a computer system 900 within which a set of instructions, for causing the machine to perform any one or more of the methodologies discussed herein, may be executed. The computer system 900 comprises, for example, any of the device machine 110, device machine 112, applications servers 118, API server 114, web server 116, database servers 124, or third party server 130. In alternative embodiments, the machine operates as a standalone device or may be connected (e.g., networked) to other machines. In a networked deployment, the machine may operate in the capacity of a server or a device machine in server-client network environment, or as a peer machine in a peer-to-peer (or distributed) network environment. The machine may be a server computer, a client computer, a personal computer (PC), a tablet, a set-top box (STB), a Personal Digital Assistant (PDA), a smart phone, a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 900 includes a processor 902 (e.g., a central processing unit (CPU), a graphics processing unit (GPU), or both), a main memory 904 and a static memory 906, which communicate with each other via a bus 908. The computer system 900 may further include a video display unit 910 (e.g., liquid crystal display (LCD), organic light emitting diode (OLED), touch screen, or a cathode ray tube (CRT)). The computer system 900 also includes an alphanumeric input device 912 (e.g., a physical or virtual keyboard), a cursor control device 914 (e.g., a mouse, a touch screen, a touchpad, a trackball, a trackpad), a disk drive unit 916, a signal generation device 918 (e.g., a speaker) and a network interface device 920.

The disk drive unit 916 includes a machine-readable medium 922 on which is stored one or more sets of instructions 924 (e.g., software) embodying any one or more of the methodologies or functions described herein. The instructions 924 may also reside, completely or at least partially, within the main memory 904 and/or within the processor 902 during execution thereof by the computer system 900, the main memory 904 and the processor 902 also constituting machine-readable media.

The instructions 924 may further be transmitted or received over a network 926 via the network interface device 920.

While the machine-readable medium 922 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to, solid-state memories, optical and magnetic media, and carrier wave signals.

It will be appreciated that, for clarity purposes, the above description describes some embodiments with reference to different functional units or processors. However, it will be apparent that any suitable distribution of functionality between different functional units, processors or domains may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

Certain embodiments described herein may be implemented as logic or a number of modules, engines, components, or mechanisms. A module, engine, logic, component, or mechanism (collectively referred to as a “module”) may be a tangible unit capable of performing certain operations and configured or arranged in a certain manner. In certain example embodiments, one or more computer systems (e.g., a standalone, client, or server computer system) or one or more components of a computer system (e.g., a processor or a group of processors) may be configured by software (e.g., an application or application portion) or firmware (note that software and firmware can generally be used interchangeably herein as is known by a skilled artisan) as a module that operates to perform certain operations described herein.

In various embodiments, a module may be implemented mechanically or electronically. For example, a module may comprise dedicated circuitry or logic that is permanently configured (e.g., within a special-purpose processor, application specific integrated circuit (ASIC), or array) to perform certain operations. A module may also comprise programmable logic or circuitry (e.g., as encompassed within a general-purpose processor or other programmable processor) that is temporarily configured by software or firmware to perform certain operations. It will be appreciated that a decision to implement a module mechanically, in dedicated and permanently configured circuitry, or in temporarily configured circuitry (e.g., configured by software) may be driven by, for example, cost, time, energy-usage, and package size considerations.

Accordingly, the term “module” should be understood to encompass a tangible entity, be that an entity that is physically constructed, permanently configured (e.g., hardwired), non-transitory, or temporarily configured (e.g., programmed) to operate in a certain manner or to perform certain operations described herein. Considering embodiments in which modules or components are temporarily configured (e.g., programmed), each of the modules or components need not be configured or instantiated at any one instance in time. For example, where the modules or components comprise a general-purpose processor configured using software, the general-purpose processor may be configured as respective different modules at different times. Software may accordingly configure the processor to constitute a particular module at one instance of time and to constitute a different module at a different instance of time.

Modules can provide information to, and receive information from, other modules. Accordingly, the described modules may be regarded as being communicatively coupled. Where multiples of such modules exist contemporaneously, communications may be achieved through signal transmission (e.g., over appropriate circuits and buses) that connect the modules. In embodiments in which multiple modules are configured or instantiated at different times, communications between such modules may be achieved, for example, through the storage and retrieval of information in memory structures to which the multiple modules have access. For example, one module may perform an operation and store the output of that operation in a memory device to which it is communicatively coupled. A further module may then, at a later time, access the memory device to retrieve and process the stored output. Modules may also initiate communications with input or output devices and can operate on a resource (e.g., a collection of information).

Although the present invention has been described in connection with some embodiments, it is not intended to be limited to the specific form set forth herein. One skilled in the art would recognize that various features of the described embodiments may be combined in accordance with the invention. Moreover, it will be appreciated that various modifications and alterations may be made by those skilled in the art without departing from the scope of the invention.

The Abstract is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A computer-implemented system, comprising
a segmentation engine implemented by one or more processors and configured to:
receive a text snippet from a search interface, the text snippet including a plurality of units separated by a separation character;
generate a plurality of unit groupings from the plurality of units;
score each unit grouping based on a frequency that the each unit grouping being present in a buyer vocabulary and further on a frequency that the each unit grouping being present in a seller vocabulary; and
generate a segmented version of the text snippet based on the scoring of the plurality of unit groupings.

2. The computer-implemented system of claim 1, wherein the plurality of unit groupings each represent a different sequence of units from the text snippet.

3. The computer-implemented system of claim 1, wherein scoring the each unit grouping includes using a segmentation function to calculate a segmentation score for the each unit grouping.

4. The computer-implemented system of claim 1, wherein a text index stores the frequency that the each unit grouping is present in the buyer vocabulary and the frequency that the each unit grouping is present in the seller vocabulary.

5. The computer-implemented system of claim 4, wherein the segmentation engine is further configured to use a grouping key to access the frequency that the each unit grouping is present in the buyer vocabulary from the text index, and use the grouping key to access the frequency that the each unit grouping is present in the seller vocabulary from the text index.

6. The computer-implemented system of claim 4, wherein the segmentation engine is further configured to prune an entry of the text index based on the entry corresponding to a frequency below a threshold.

7. The computer-implemented system of claim 1, wherein the segmentation engine is configured to score each unit grouping by further scoring each of the units based on a size of the each unit grouping.

8. The computer-implemented system of claim 1, wherein the segmentation engine is further configured to classify the text snippet with a category.

9. The computer-implemented system of claim 8, wherein the frequency that the each unit grouping is present in the buyer vocabulary is specific to the category, and the frequency that the each unit grouping is present in the seller vocabulary is specific to the category.

10. The computer-implemented system of claim 1, wherein the buyer vocabulary includes queries previously executed within a networked system, and the seller vocabulary includes data being offered for sale on the networked system.

11. A computer-implemented method, comprising
receiving a text snippet from a search interface, the text snippet including a plurality of units separated by a separation character;
generating a plurality of unit groupings from the plurality of units;
scoring, by one or more processors, each unit grouping based on a frequency that the each unit grouping being present in a buyer vocabulary and further on a frequency that the each unit grouping being present in a seller vocabulary; and
generating a segmented version of the text snippet based on the scoring of the plurality of unit groupings.

12. The computer-implemented method of claim 11, wherein the plurality of unit groupings each represent a different sequence of units from the text snippet.

13. The computer-implemented method of claim 11, wherein scoring the each unit grouping includes using a segmentation function to calculate a segmentation score for the each unit grouping.

14. The computer-implemented method of claim 11, wherein a text index stores the frequency that the each unit grouping is present in the buyer vocabulary and the frequency that the each unit grouping is present in the seller vocabulary.

15. The computer-implemented method of claim 14, further comprising using a grouping key to access the frequency that the each unit grouping is present in the buyer vocabulary from the text index, and using the grouping key to access the frequency that the each unit grouping is present in the seller vocabulary from the text index.

16. The computer-implemented method of claim 14, further comprising pruning an entry of the text index based on the entry corresponding to a frequency below a threshold.

17. The computer-implemented method of claim 11, wherein the scoring of each unit grouping is further based on a size of the each unit grouping.

18. The computer-implemented method of claim 11, further comprising classifying the text snippet with a category.

19. The computer-implemented method of claim 18, wherein the frequency that the each unit grouping is present in the buyer vocabulary is specific to the category, and the frequency that the each unit grouping is present in the seller vocabulary is specific to the category.

20. A non-transitory computer-readable medium storing executable instructions thereon, which, when executed by a processor, cause the processor to perform operations comprising:
receiving a text snippet from a search interface, the text snippet including a plurality of units separated by a separation character;
generating a plurality of unit groupings from the plurality of units;
scoring each unit grouping based on a frequency that the each unit grouping being present in a buyer vocabulary and further on a frequency that the each unit grouping being present in a seller vocabulary; and
generating a segmented version of the text snippet based on the scoring of the plurality of unit groupings.
